(19) United States
(12) Patent Application Publication
(10) Pub. No.: US 2025/0265055 A1
(43) Pub. Date: Aug. 21, 2025

(54) OPERATION SYSTEM-LEVEL INSTRUMENTATION TO AUTOMATICALLY INFER SOFTWARE DEPENDENCIES

(71) Applicant: Oracle International Corporation, Redwood Shores, CA (US)

(72) Inventors: Guochao Xie, Zurich (CH); Christopher Ferreira, Zurich (CH); Hugo Guiroux, Zurich (CH)

(21) Appl. No.: 18/790,630

(22) Filed: Jul. 31, 2024

Related U.S. Application Data
(60) Provisional application No. 63/555,261, filed on Feb. 19, 2024.

(51) Int. Cl. G06F 8/41

(52) U.S. Cl. CPC G06F 8/433

(57) ABSTRACT

Herein is software dependency reporting with an innovative framework to analytically generate a software bill of materials (SBOM) that is a list of dependencies of a software application that was built in an opaque (i.e. black-box) way. This approach makes minimal assumptions about the build framework(s) and language ecosystem(s) involved with building a software application. For building a deliverable based on source files defined in separate programing languages, source files are read and deliverable files are generated and copied. Unique identifiers of accessed files are recorded by novel probes into a probe log having unprecedented accuracy. The probe log is analyzed to generate a provenance graph that contains a vertex for each file accessed by the build. By graph analytics, a dependency report having unprecedented accuracy is generated for the deliverable from the provenance graph.

### BENEFIT CLAIM

This application claims the benefit under 35 U.S.C. § 119 (c) of provisional application 63/555,261, filed Feb. 19, 2024, by Christopher Ferreira et al., the entire contents of which is hereby incorporated by reference. The applicant hereby rescinds any disclaimer of claim scope in the parent applications or the prosecution history thereof and advise the USPTO that the claims in this application may be broader than any claim in the parent application FIELD OF THE DISCLOSURE

This disclosure relates to software dependency reporting. Accuracy of a provenance graph is increased by operating system (OS) instrumentation that observes a build of a deliverable by compilers of multiple programing languages.

### BACKGROUND

A software application may be based on dozens of third-party software libraries, which may make auditing the composition of the application technically challenging. A software bill of materials (SBOM) is a detailed manifest of the composition of a software application As a technical document, an SBOM may be used for the following example purposes. An SBOM can increase computer security. By listing all the components that make up a piece of software, an SBOM helps an organization identify potential security vulnerabilities. If a known vulnerability exists in a particular component, SBOMs can help the organization quickly identify which software programs are at risk and take steps to patch those programs.

An SBOM can decrease supply chain risk, which is a technical concern. Software is often built using components from many different parties. An SBOM provides visibility into an entire software supply chain, which can help an organization identify and mitigate risks associated with third-party components. An SBOM can increase software license compliance, which is a technologic concern. An SBOM can help an organization ensure that the organization is complying with the licensing terms of all the software components used inside an application. An SBOM can increase software quality. An SBOM can help a development team track and manage the quality of the team's software by providing a clear picture of the components that are used for the application. This can help to identify potential issues early in the development process.

Generating an accurate SBOM is a technologic challenge for the following reasons. There may naturally be limited visibility into software that is complex with many internal layers. It can be difficult to obtain complete visibility into all components in an application, especially for legacy code or third-party libraries with limited documentation and, for example, no source code. Hidden dependencies or manual integrations that occurred to build an application might be missed by a state of the art SBOM. Highly complex applications, legacy code, or situations with limited access to information can make generating a perfectly accurate SBOM challenging. For example, a software development environment may be dynamic and constantly evolving. New libraries might be added, versions might be updated, or configurations might change without proper documentation.

Some SBOM tools are tied to a particular build framework. For example, Maven and Gradle are build frameworks for Java, and Poetry is a build framework for Python. A multilingual (i.e. multiple programing languages) software application may require multiple build frameworks, which a state of the art SBOM tool may be more or less unable to accommodate. For example, a polyglot application may have multiple dependency management systems (e.g. version management). Different languages often have their own package managers and dependency resolution methods. This means there can be multiple sources of truth for what components a polyglot application actually is built from. A state of the art SBOM tool may be more or less unable to handle different package managers. Incomplete polyglot support can cause missing (i.e. unlisted) components in the SBOM. For example, a programing language might have hidden dependencies that are not explicitly declared in a package manager. These dependencies can be difficult to track down and include in the SBOM.

Accuracy of an SBOM can be quantitatively measured. For example, a count of components (e.g. files or libraries or packages) listed in an SBOM may measurably differ from a known correct count. By increasing or decreasing accuracy of a generated SBOM, a generative computer technique effectively increases or decreases the technical accuracy of a generative computer itself.

### BRIEF DESCRIPTION OF THE DRAWINGS

In the drawings:

FIG. 1 is a block diagram that depicts an example computer that generates probes that are operating system (OS) instrumentation that observe the building of a software deliverable, such as a containerization image, by multiple compilers of respective programing languages;

FIG. 2 is a flow diagram that depicts an example computer process that performs an instrumented compilation stage that entails recording;

FIG. 3 is a flow diagram that depicts an example computer process that performs an analytic stage that generates a provenance graph and a dependency report;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Herein is software dependency reporting with a framework to analytically generate a software bill of materials (SBOM) that is a list of dependencies of a software application that was built in an opaque (i.e. black-box) way. This approach makes minimal assumptions about the build framework(s) and language ecosystem(s) involved with building a software application. An embodiment may use an operating system (OS) kernel-level instrumentation mechanism to monitor build activity (including file access, process creation, and library loading) and analytically infers dependencies from these activities. The direct benefits of this approach is the general applicability of the framework with seamless support for polyglot (several language ecosystems) and complex projects that, for example, may have a proprietary or nonstandard build system.

This framework can generate an SBOM of a project with support for several build ecosystems and with minimal customization efforts. Generation of a unified SBOM with high accuracy is achieved, including minimizing false positives. Accuracy of provenance graph generation is increased by operating system (OS) instrumentation that observes a build of a software deliverable by compilers of multiple programing languages.

An embodiment may discriminate between dependencies that are only necessary at build-time from dependencies that are necessary at runtime. For example, a Java project may be built by Maven that loads its own Java plugin for its own internal purpose. With probes herein that operate as build process observation hooks, this approach instruments the loading of machine-code libraries (e.g., dlopen system calls) and further has specific instrumentation for non-machine code loading such as class loading of Java bytecode. An embodiment may have an offline discovery phase that is a design phase that is used to add support for a new build ecosystem or programing language. Achieving optimal support for a new build ecosystem can be done with build containers that encompass the characteristics of a build ecosystem to discover additional probes that are necessary as discussed later herein. The offline discovery phase autonomously identifies and summarizes probes relevant to the build ecosystem by performing several runs of the build, focusing the instrumentation on a few relevant events (e.g., read event) and looking at the full call stack to find out the relevant user-space functions. These discovered probes can be persisted and the offline discovery does not need to be repeated for a same build ecosystem. The offline discovery phase is used to increase accuracy and minimize false positives, which entails additional probes that can offer supplemental information tailored for a specific build ecosystem.

After the offline discovery phase is a phase referred to herein as a build phase that consists of a compilation stage followed by an analytic stage. The compilation stage uses probes to observe and record relevant kernel-level and user-space events that occur during a build, such as file access, process creation, and library loading. Herein, probes are streamlined to perform limited lightweight processing (e.g., resolving a path from file identifier) and collect all necessary events into an events log, also referred to herein as a build log or a probe log. In an embodiment, instrumentation is performed using extended Berkeley packet filter (eBPF) that enables the execution of sandboxed programs in a Linux kernel without any changes to the kernel or loading of a kernel module. Instrumentation discussed later herein include kernel probes (kprobes), user probes (uprobes), and tracepoints to capture states in both kernel and user spaces.

The analytic stage is postprocessing that converts the resulting events log into a build provenance graph. Each vertex in the graph represents an entity, such as a file or a build process, and each edge in the graph represents a build activity such as downloading, compiling, or packaging. Edges denote the interactions between entities. Filesystem-level activity is observed to reveal relationships between processes and files. Entities are identified by either the file path or the process ID (PID). Metadata of activities may include some or all of: entity_from, entity_to, time interval, event type, and supplemental information such as a call stack of the activity. The build provenance graph is a logical graph that serves as a crucial intermediate product for conducting generalized and comprehensive software dependency analysis. Herein, customizable rules are used to produce an SBOM from a build provenance graph.

The customizable rules guide analysis of the provenance graph, allowing for the granular annotation of activities observed by probes identified within the call stack. Starting from the artifact vertex as a root vertex that represents the final deliverable product of a build, the rules systematically process the build provenance, identifying reachable vertices as potential dependencies. Special rules further categorize these candidates into non-dependencies, build-time dependencies, compiled dependencies, runtime dependencies, or test dependencies. For example, after executing instrumentation of Java class loading probes that were identified in the offline discovery phases, an annotation rule may be applied to designate such activity as reads initiated by Maven or Gradle's Java class loader. Consequently, these files are detected as build-time dependencies. To infer SBOM metadata, this approach extracts package names and versions from the file paths. Additionally, this approach can leverage a dependency database, querying it using a file checksum to obtain more comprehensive information.

Example build frameworks include Maven and Gradle for Java, Cargo for Rust, Go, Conan for C++, and Makefile. For Maven, Gradle, Cargo, and Go, this approach generates an SBOM for compiled dependencies with perfect accuracy and no false positives, which is unprecedented. This approach has at least the following innovations. Use of an instrumentation mechanism to monitor kernel-level events is novel during a build to detect the dependencies of the project being built while they are being used to build the project. The state of the art did not use a build provenance graph to generate an SBOM. Graph analytics to distinguish build-only dependencies from actual dependencies is innovative. The above offline discovery phase is a new way to design build instrumentation.

This approach has at least the following advantages. A polyglot source base and multiple build frameworks are seamlessly handled during a single build. Build framework agnosticism means that proprietary and exotic build frameworks are readily accommodated. Which kinds of dependencies to include in an SBOM is configurable, and classification of dependencies by kind is based on rules that can be configured to achieve perfect or near perfect accuracy of classification.

### 1.0 Example Computer

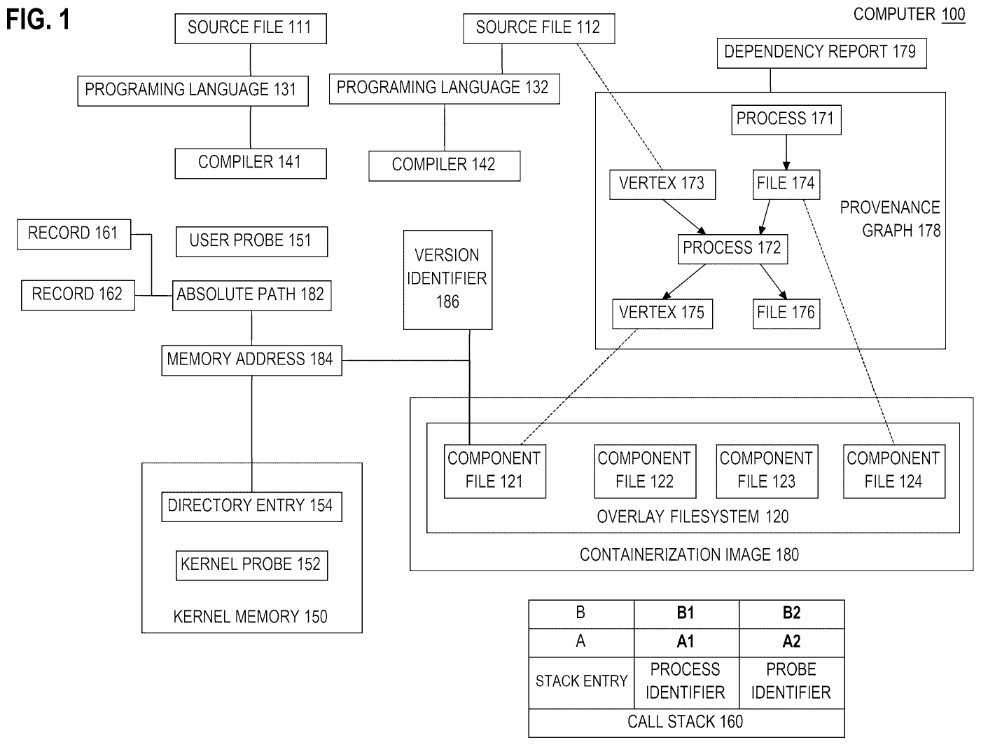

FIG. 1 is a block diagram that depicts example computer 100 that generates probes 151-152 that are operating system (OS) instrumentation that observe the building of a software deliverable, such as containerization image 180, by multiple compilers 141-142 of respective programing languages 131-132. As discussed later herein, provenance graph 178 and software dependency report 179 are generated with accuracy increased by operation of probes 151-152. All components shown in FIG. 1 are variously stored or generated in volatile or nonvolatile storage of computer 100. Computer 100 may be one or more of a rack server such as a blade, a mainframe, a virtual machine, or other computing device.

1.1 Deliverable Software Application Built from Polyglot Source Base

Herein, a deliverable is a codebase of a custom application whose internal complexity and architectural composition is not limited herein. In one example, an application is a web application that consists of a sequence of three tiers (not shown) that are a presentation tier, an application tier, and a data tier, and each tier may consist of a respective distinct computer program such as a web server, an application server, and a database server. In other examples, an application is client-server (i.e. two tier) or standalone (i.e. one tier).

Each tier in a tiered application may consist of a distinct set of codebase files that are generated or packaged in a distinct respective way. In one example, a presentation tier contains static files such as webpages and stylesheets that are ready to use, as is, without compilation. In one example, programing language 131 is JavaScript, source file 111 is a text file that contains JavaScript, and compiler 141 is a JavaScript bundler such as webpack that parses and processes source file 111 by compression that removes extraneous whitespace and refactoring that splits source file 111 into multiple smaller JavaScript text files for acceleration of a web browser. Thus, the codebase of a tier may consist of a mix of: a) static files that preexist operation herein of computer 100 and b) files generated by operation herein of computer 100.

For example, an application tier may contain classes or modules that computer 100 should transform into object code such as bytecode or native machine code. In one example, programing language 132 is Java, compiler 142 is a Java compiler, and source file 112 is a text file that contains Java source code. In various examples, each tier of a multitier application has its own compiler and programing language, or two tiers share a same programing language and compiler. Herein, a polyglot application is an application whose construction requires computer 100 to operate compilers 141-142 of multiple programing languages 131-132.

The goal of computer 100 is to generate a software deliverable such as containerization image 180 that is discussed below. Operation herein of computer 100 entails only building the deliverable application and generating the deliverable's accompanying dependency report 179. Computer 100 neither installs nor runs the built application.

Herein, a deliverable (i.e. codebase) may consist of one or more files including, for example, any of the various archive file formats, executable file formats, and configuration file formats discussed herein. This approach is not limited to a particular kind of deliverable nor a particular kind of file(s).

### 1.2 Overlay Filesystem in Containerization Image

Depending on the embodiment, building the deliverable may or may not entail containerization or an overlay filesystem. In an example not shown: a) a deliverable application may be one or more executable files such as an executable and linkable format (ELF) file that contains native machine code, and b) the deliverable does not have shown components 120 and 180. In an embodiment, the deliverable comprises a configuration file such as a text file that is a property file, a comma separated values (CSV) file, a JavaScript object notation (JSON) file, or an extensible markup language (XML) file.

In the shown exemplary embodiment, containerization image 180 is an application's persistent codebase, from which a containerization container could later (e.g. not by computer 100) be instantiated to run the application. For nonlimiting case of demonstration, discussion herein may presume that: a) containerization image 180 conforms to the Open Container Initiative (OCI) image format that consists of a sequence of file layers, where each layer consists of multiple files, and b) containerization image 180 is, for example, a Docker image that consists of overlay filesystem 120 as OCI's sequence of file layers.

In one scenario, overlay filesystem 120 consists of a sequence of three file layers that are an operating system (OS) layer, a software library layer consisting of third-party code libraries, and an application specific layer that contains, for example, files generated by compilers 141-142. The OS file layer consists of OS tools such as a shell command line interface (CLI), shell commands and utilities, and scripting language interpreters such as python. In the case of lightweight containerization such as Docker, the OS file layer contains OS tools but does not contain an OS kernel.

Herein, a file has one of two mutually-exclusive roles that are a component file and a source file. Component files 121-124 are also referred to herein as deliverable files because they are physically contained in the built application. A component file may be generated by computer 100 or preexisting as discussed earlier herein. File layers are not shown in FIG. 1, and component files 121-124 may or may not be in a same layer. Source files 111-112 are used by computer 100 to build the application but are not contained in the built application.

### 1.3 Instrumentation Probes

The goal of computer 100 is to generate: a) a deliverable such as containerization image 180 and b) dependency report 179 that describes the internal composition of the deliverable. Herein, generation of the deliverable application is referred to as a build phase. As follows, probes 151-152 are instrumentation that monitors (i.e. records observations about) an ongoing build phase. As discussed later herein, those recorded observations (e.g. data structures 154, 160-162, 182, and 184) are analytically postprocessed (i.e. after the build phase finishes) to generate data structures 178-179.

Probes 151-152 are configurable extensions to the OS (not shown) of computer 100 that are implemented as callbacks such as a listener or observer. Probes 151-152 observe file access by the build phase such as: a) reading of source files 111-112, b) generation of some or all of component files 121-124, and c) copying of component files 121-124 into overlay filesystem 120. For each file accessed, a corresponding one of records 161-162 may be generated as follows, and probes 151-152 are implemented as follows.

Each of probes 151-152 may observe, for example, a respective phase of a lifecycle of a respective file access subroutine (not shown). In one example, probes 151-152 are configured to observe entry (i.e. invocation) into a distinct respective subroutine. In another example: a) probe 151 is configured to observe entry into a subroutine, and b) probe 151 is configured to observe exit (i.e. return) from that subroutine.

### 1.4 Build Phase Recording of System Calls

Each invocation of either of probes 151-152 generates and retains exactly one record in the probe log. In one example, records 161-162 are generated by respective invocations of distinct probes 151-152. In another example, records 161-162 are generated by respective distinct invocations of a same probe.

Computer 100 may register probes 151-152 with the OS of computer 100. Registration of a probe may entail associating a reference to the probe with a reference to the subroutine to be observed. In an embodiment: a) the reference to the subroutine is a function pointer that is the memory address of the subroutine, and b) the reference to the probe is the memory address of a one-dimensional array of bytecodes that implement the probe. In another embodiment, the subroutine to be observed is an OS system call, and the reference to the subroutine is an integer or name (i.e. text string) that uniquely identifies the system call.

For example if the OS system call is vfs_read, which reads part of a file from a local drive or from a cross-mounted (i.e. remote, e.g. network filesystem, NFS) filesystem, then kernel probe 152 is invoked when the build phase reads part of a local or remote file. When invoked by the OS, probes 151-152 are provided with contextual arguments. For example, an argument may indicate which file is being read by vfs_read.

### 1.5 Directory Entries in Kernel Memory

In an embodiment, the OS operates filesystems by generating and temporarily retaining, in random access memory (RAM) of computer 100, a distinct directory entry for each file accessed. Herein, a directory entry is a data structure that represents a file, and the memory address of the directory entry effectively is a unique identifier of the file. In the shown example: a) component file 121 is temporarily represented by directory entry 154 that resides at memory address 184, and b) kernel probe 152 generates records 161-162 that each contains absolute path 182 that is a file path that corresponds to memory address 184 as discussed later herein.

For example: a) the build phase generating component file 121 may cause generation of components 154, 161, 182, and 184, and b) the build phase copying component file 121 into overlay filesystem 120 may cause generation of record 162 and reuse of retained components 154, 182, and 184. In various embodiments and scenarios that observe access of a file, either of records 161-162 may contain some or all of: a version identifier of the file, a kernel memory address of the directory entry of the file, a name of a Unix system call, a name of a kernel function, and a uniform resource locator (URL) of the file.

In an embodiment, a probe may be an extended Berkeley packet filter (eBPF) tracepoint (not shown). A tracepoint and a kernel probe are two kinds of probes that observe internal operation of the OS kernel. The (e.g. virtual) memory space of computer 100 is divided into kernel space that is mostly private to the OS and user space that is mostly private to an application. A tracepoint observes an OS event. A kernel probe observes a system call. A user probe observes a subroutine in user space such as an application subroutine such as a subroutine in a third-party library. All three probe types are supported by eBPF.

User probes do not have access to kernel memory 150, which is RAM in which the OS kernel retains internal data structures such as directory entry 154. For example, memory address 184 may be within the address range of kernel memory 150. In other words, memory address 184 may be a kernel memory address.

### 1.6 Multiple Complementary Probes Observing Interelated Events

For example, kernel probe 152 may observe a system call such as vfs_open that opens a file for access. For example, generating or copying component file 121 may entail opening component file 121 and generating or reusing components 154, 182, and 184. Herein, records 161-162 are also referred to as probe records. The following example scenario generates four probe records.

The lifecycle of components 120 and 180 consists of a build phase in computer 100 followed by a runtime phase that may occur in a different computer. Components 120 and 180 operate only in the runtime phase. Techniques herein do not regard the runtime phase. In other words, techniques herein do not entail operation of components 120 and 180 and, herein, components 120 and 180 are passive data structures that may consist of sets of files.

For example during the build phase, overlay filesystem 120 does not operate as a filesystem, and component files 121-124 are passively in overlay filesystem 120 but operationally in a non-overlay filesystem of computer 100. That is during the build phase, computer 100 mounts the non-overlay filesystem and does not mount overlay filesystem 120. In other words during the build phase, all file access occurs through the non-overlay filesystem such as follows.

In the following exemplary embodiment, components 120 and 180 may be implemented as a set of files in a non-overlay filesystem in computer 100, and kernel probe 152 observes, for example, system call vfs_open in the non-overlay filesystem. In that case, each invocation of kernel probe 152 receives as arguments both of: a) a kernel memory address of a directory entry of a file being opened and b) an indication of whether the file is being opened for reading or writing. Invoking kernel probe 152 may entail either or both of: a) executing kernel probe 152 in kernel mode of the OS and b) executing bytetcode of kernel probe 152. A user probe operates in user mode of the OS instead of kernel mode.

### 1.7 Filesystem Metadata

During the build phase, computer 100 may generate a map (not shown) of all files accessed by the build phase, and the map consists of key-value pairs where, for each accessed file, the key is the memory address of the directory entry of the file, and the associated value is the file path of the file. For example, the map may associate memory address 184 with absolute path 182 as shown, where absolute path 182: a) is not contained in directory entry 154 and b) is the file path of component file 121 in the non-overlay filesystem. In an embodiment: a) a file path consists of a filename after a sequence of folder (i.e. directory) names, b) a parent folder contains child folders and child files, and c) a child directory entry contains a reference to its parent directory entry.

For example, component file 121 may reside in a child folder whose parent folder is the root folder of the non-overlay filesystem. In that case: a) each of three directory entries are respectively for component file 121, the child folder, and the root folder, and b) the references from child directory entries to parent directory entries form a singly linked list that consists of the three directory entries. When kernel probe 152 first receives memory address 184: a) computer 100 detects that the map does not contain memory address 184, b) computer 100 generates absolute path 182 by traversing the linked list of directory entries, and c) an association between components 182 and 184 is stored in the map.

In a subsequent invocation of kernel probe 152 with same memory address 184, computer 100 detects that the map already contains memory address 184. In that way, the linked list is traversed to generate absolute path 182 only once during the build phase, no matter how many invocations of various probes receive memory address 184 as an argument. All probes share a single global map.

### 1.8 Provenance Graph Generation

In an embodiment, component files 121-124 are not generated in overlay filesystem 120 and instead are copied into overlay filesystem 120 after being generated. In that case, the build phase may occur in two stages that are a compilation stage that generates any of component files 121-124 that do not preexist, followed by a packing stage that copies component files 121-124 into overlay filesystem 120. For example after copying, two copies of component file 121 may exist, which computer 100 handles as follows when generating provenance graph 178 and its vertices from records 161-162 as follows.

The build phase may spawn (i.e. generate) many build processes that each has a distinct respective process identifier (PID) assigned by the OS. Each of records 161-162 indicates a distinct access of a respective file, and each of records 161-162 contains all of: a) an absolute path of the file, b) a PID of a respective build process that performed the file access, c) an identifier of the respective observed subroutine (e.g. system call) that implements the access, and d) a timestamp of the access. That is, each record associates a respective build process with a respective file.

Herein, after the build phase is an analytic phase that analyzes records 161-162 to generate components 178-179. Although multiple records may contain a same PID or a same file path, for provenance graph 178, only one respective vertex is generated for each build process and for each accessed file. For example as shown in provenance graph 178, file 174 is a third-party library file that is: a) downloaded from the Internet by process 171, b) read by process 172 (e.g. an invocation of compiler 142 that compiles source file 112), and c) copied into overlay filesystem 120 as component file 124.

Vertices 173-176 are file vertices that represent respective distinct files. Dashed lines extending out of provenance graph 178 are demonstrative to indicate respective files of some file vertices. Edges between vertices are shown as directed arrows. An arrow that extends from a process vertex to a file vertex is a producer arrow that indicates that a producer process produces the file (e.g. by generation or download), in which case: the file depends on the process, and the process is a dependency of the file. An arrow that extends from a file vertex to a process vertex is a consumer arrow that indicates that the process reads the file, in which case: the process depends on the file, and the file is a dependency of the process.

By filtration discussed later herein, computer 100 may discard some of records 161-162 as irrelevant (i.e. not used to generate provenance graph 178). For each record not discarded, a respective distinct edge is generated in provenance graph 178. Each connects two vertices. Herein, edge 171→174 is the shown edge that connects vertices 171 and 174.

Postprocessing a record to generate edge 171→174 may entail: a) detecting that provenance graph 178 already contains none, one, or both of vertices 171 and 174, and b) generating and inserting none, one, or both of vertices 171 and 174 that are missing into provenance graph 178. For example, three records may occur in a particular temporal ordering for which three edges may later be generated and inserted in the same following ordering: 1) postprocessing a first record causes generation of vertices 171 and 174 and then generation of edge 171→174, 2) postprocessing a second record causes generation of vertices 173 and 172 and then generation of edge 173→172, and 3) postprocessing a third record causes generation of edge 174→172 by reuse of vertices 172 and 174 without generating any vertex. That is, postprocessing each un-discarded record causes generation of zero, one, or two vertices and exactly one edge.

### 1.9 Probe Stack

As discussed earlier herein, entry and exit of an observed subroutine may be separate observations. In an embodiment, the build phase maintains call stack 160 that is a shadow stack that is not an actually operating call stack. Because call stack 160 tracks probe invocations only, call stack 160 may be referred to as a probe stack. Each stack entry in call stack 160 contains: a) the PID of a respective build process that invoked an observed subroutine and b) an identifier of a probe that observed the invocation of the subroutine. Call stack 160 does not contain pointers (i.e. memory address references).

During the build phase, call stack 160 grows upwards. For example in call stack 160, stack entry A is older than stack entry B, which means that: a) probe A2 observed, for example, an invocation of a first system call before probe B2 observed an invocation of a second system call, and b) the second system call returned before the first system call. Here, (b) means that stack entry B will be popped (i.e. removed) from call stack 160 before stack entry A is popped. In other words, the second system call was nested inside the first system call. For example, the first system call may have directly or indirectly invoked the second system call and PIDs A1-B1 may or may not be identical.

Values shown bold in call stack 160 are stored in call stack 160. Values not shown bold in call stack 160 are demonstrative (i.e. implied) and are not stored in call stack 160.

### 1.10 Dependency Report Generated by Graph Analytics

Dependency report 179 is generated from provenance graph 178 as discussed later herein. Dependency report 179 may be a software bill of materials (SBOM) that lists component files in a detailed way. For example, dependency report 179 may be a text file such as a spreadsheet or a semi-structured document such as JSON or XML. Dependency report 179 may contain a name, version, and original creation timestamp of the deliverable or of any component file in the deliverable.

A third party library may be a component file such as an archive (.a file), a tape archive (tar) file, a Java archive (jar) file, a shared object (.so file), a dynamically linked library (.dll file), or executable (e.g., exe file). Dependency report 179 may contain: a) a copy or universal resource locator (URL) of a software license of the library and b) a URL of a homepage of the library. In the library is a software package that is installed and registered with the operating system (OS) of computer 100, then dependency report 179 may contain the name of the package. In an embodiment, dependency report 179 may contain an identifier or URL of a known security vulnerability of a library.

### 2.0 Example Probe Log Generated by Example Build Phase Process

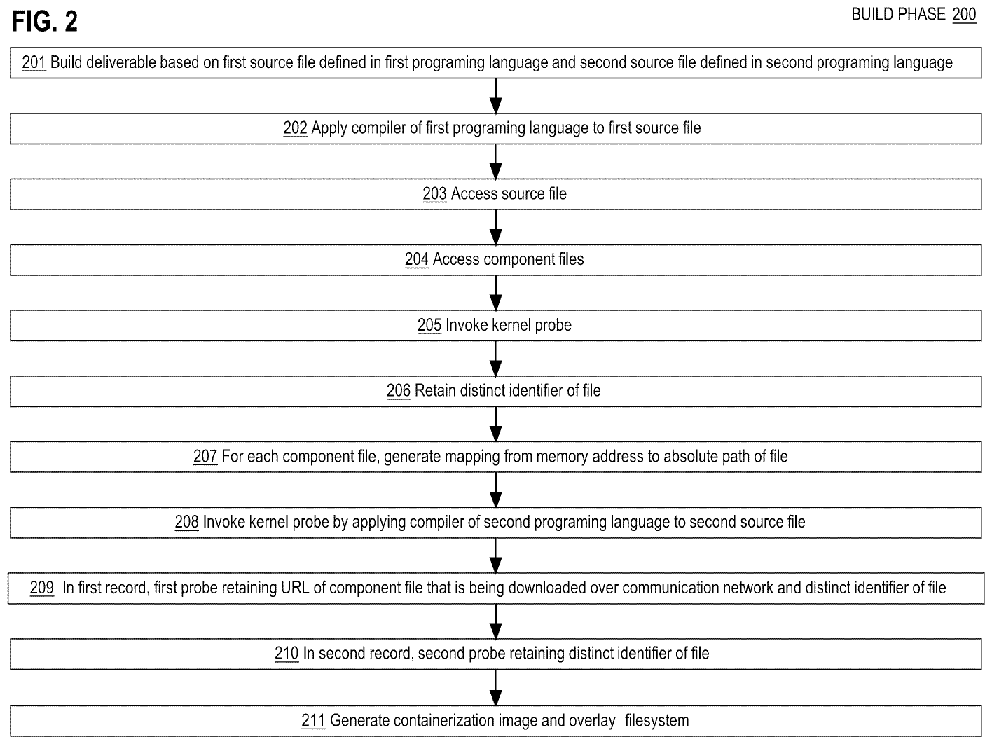

As discussed earlier herein, the lifecycle of computer 100 consists of a build phase followed by an analytic phase. FIG. 2 is a flow diagram that depicts build phase 200 that is an example process that computer 100 may perform as follows to generate a probe log.

Step 201 performs build phase 200. Steps 202-211 are sub-steps of step 201. Based on source files 111-112, polyglot step 201 builds a software deliverable such as containerization image 180 as discussed earlier herein.

As discussed earlier herein, build phase 200 consists of a compilation stage followed by a packing stage that entails step 211. Steps 202-210 perform the compilation stage as follows. Step 202 uses compiler 141 to compile source file 111 as discussed earlier herein. Steps 203-206 are sub-steps of step 202 that causes steps 203-206.

In step 203, compiler 141 reads (e.g. parses) source file 111 as discussed earlier herein. As discussed earlier and later herein, into overlay filesystem 120, packing step 211 can copy (i.e. read) component files that compiler 141 generates. Thus, step 204 may be repeated at different times to write or read some component files that are being generated into a non-overlay filesystem or copied into overlay filesystem 120.

Accessing a component file or a source file may cause the OS in step 205 to invoke kernel probe 152 as discussed earlier herein. Kernel probe 152 reacts by performing step 206 that retains components 182 and 184, each of which is a distinct identifier of, for example, component file 121. Repetition of step 206 for different (e.g. source or component) files causes step 207 to generate a global mapping from the memory address of each accessed file to the absolute path of the file as discussed earlier herein.

In step 208, other compiler 142 reads source file 112 as discussed earlier herein. This causes the OS in step 208 to invoke same kernel probe 152. In other words, kernel probe 152 may be (i.e. indirectly) invoked by different compilers for different (e.g. source) files.

In one scenario that entails two probes observing different respective phases of the lifecycle of a component file, steps 209-210 occur as follows. For example from a third-party, step 209 downloads a dependency that is a file that, for example, source file 111 or 112 depends on, such as a code library, and packing step 211 may or may not copy the downloaded file into overlay filesystem 120 (i.e. as a component file). For example while compiling source file 111: a) a first probe in step 209 may observe the file being downloaded and saved (i.e. written) into the non-overlay filesystem by compiler 141, and b) a second probe in step 210 may observe the file being read from the non-overlay filesystem by compiler 141.

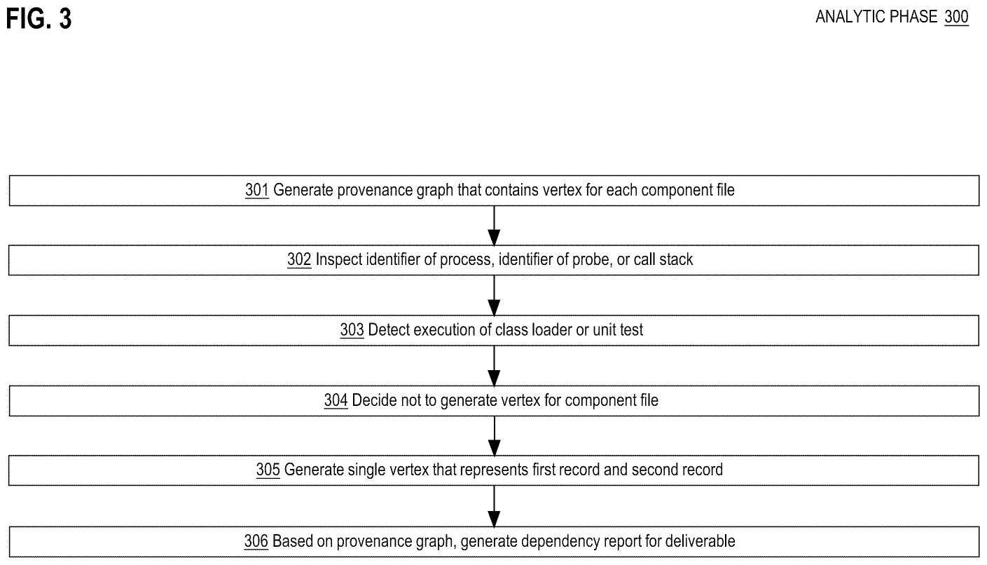

For example in record 161 in step 209, the first probe may retain: a) a uniform resource locator (URL) of a component file that is being downloaded over a communication network and b) absolute path 182 as a distinct identifier of the file. After step 209 saves the downloaded file to disk, then compiler 141 may read the file in step 210. In record 162 in step 210, the second probe retains same absolute path 182. When multiple records contain a same file identifier or process identifier, a multistage lifecycle of a file may be accurately analyzed as discussed later for FIG. 3.

Packing step 211 generates containerization image 180 and overlay filesystem 120 that contains component files 121-124 as discussed earlier herein.

### 3.0 Example Dependency Report Generated by Example Analytic Phase Process

As discussed earlier herein, the lifecycle of computer 100 may consist of build phase 200 followed by an analytic phase. FIG. 3 is a flow diagram that depicts analytic phase 300 that is an example process that computer 100 may perform as follows.

Step 301 analyzes records 161-162 and responsively generates provenance graph 178 that contains a respective vertex for each of many component files in overlay filesystem 120. Steps 302-305 are sub-steps of step 301 as follows.

Step 302 inspects, in record 161-162, process identifiers (PID) A1-B1, probe identifiers A2-B2, and call stack 160 as discussed earlier herein. Based on inspection of those records, steps 303-304 may make various detections and decisions such as follows.

In an embodiment, computer 100 may contain rules (e.g. logic) that classifies some dependencies as a build dependency or a test dependency that in some embodiments should be excluded from dependency report 179. A test dependency is a dependency that arises during the build phase, but only during execution of an automated test. Step 303 detects in provenance graph 178 that a vertex or edge represents a record that represents an execution of a class loader or a unit test. The following is an example rule that detects that an edge or record represents operation of a (e.g. Java) class loader that occurred during the build phase.

if <the call stack of a file read event contains a discovered JVM class loading probe> then <categorize as a build dependency>

In the above example rule, the “then” keyword separates a condition on the left from a reaction on the right, and both the condition and reaction are demonstratively enclosed in angle brackets. For example, the above example rule may inspect a vertex or record that specifies a file read event more or less as follows.

Loaded org.gradle.cache.internal.filelock.LockFileAccess from . . . /lib/gradle-core-2.8.jar

The above example rule may detect that the above example event identifies a Gradle file that is a build dependency that should be excluded from dependency report 179. If build dependencies should be included in dependency report 179, then generation of dependency report 179 may entail tokenizing the filename “gradle-core-2.8.jar” to detect: a) “gradle-core” is a package installed on computer 100 and b) the package or library is version 2.8.

In various cases, step 304 decides not to generate a vertex in provenance graph 178 for a process or component file. For example, copying a component file into overlay filesystem 120 may entail reading the file and then writing a copy of the file. Even though the file and its copy are two files that are respectively identified in two records, analytic phase 300 may represent both files by a single vertex. For example, step 305 may generate a single vertex that represents both records 161-162 that identify separate, but identical, respective files. The following is an example rule that detects that a record represents a download of a component file such as a library.

if <the filesystem name is sockfs> then <consider read as a download>

Dependency report 179 may be a software bill of materials (SBOM) that lists component files in a detailed way as discussed earlier herein. Based on provenance graph 178, step 306 generates dependency report 179 for the software deliverable (e.g. containerization image 180). For example, an individual edge, or a sequence of two adjacent edges that are adjacent in one directed traversal of part of provenance graph 178, may indicate a dependency of containerization image 180 on a component file such as a library.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

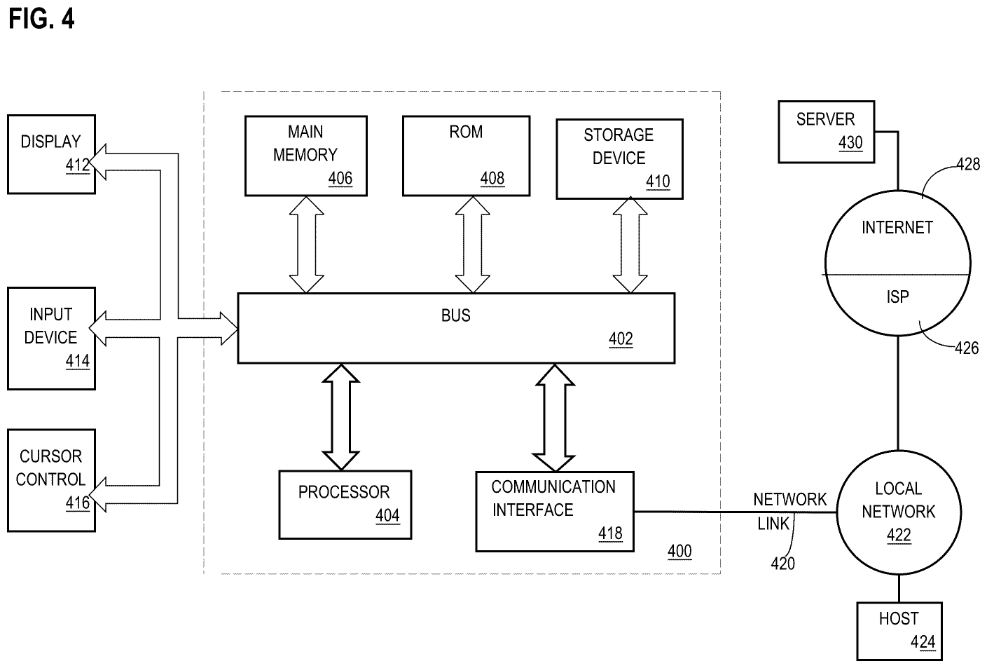

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

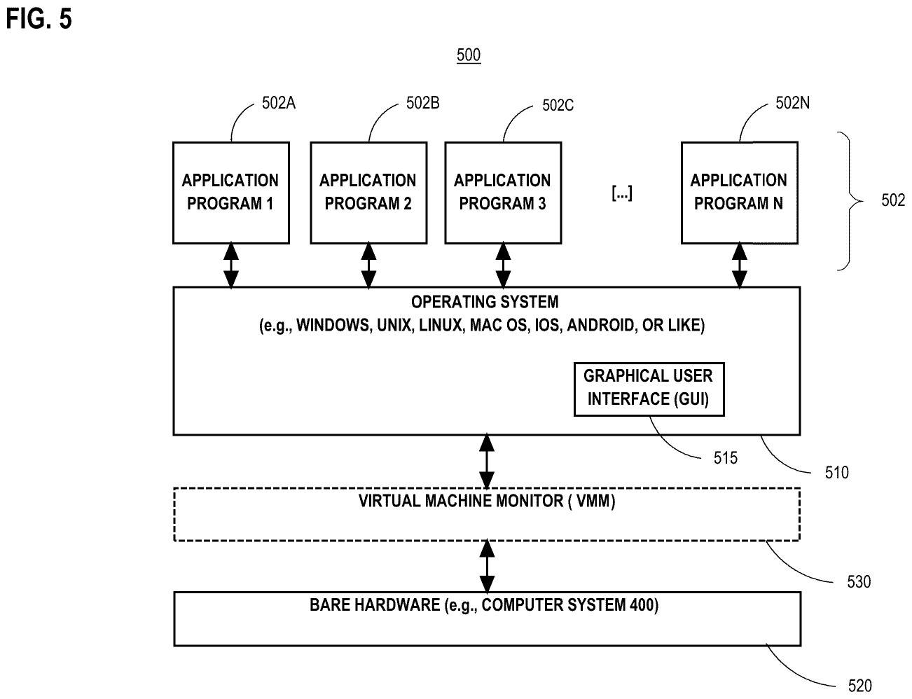

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 500 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
building a deliverable based on a first source file defined in a first programing language and a second source file defined in a second programing language, wherein:
the building comprises accessing each file of a plurality of component files, and
the accessing each file of the plurality of component files comprises retaining a distinct identifier of the file;
generating a provenance graph that contains a vertex for each file of the plurality of component files, wherein the vertex contains the distinct identifier of the file; and
generating, based on the provenance graph, a dependency report for the deliverable.

2. The method of claim 1 wherein said retaining the distinct identifier of each file of the plurality of component files comprises retaining at least one selected from a group consisting of:
a version identifier of the file,
a kernel memory address,
a name of a unix system call,
a name of a kernel function, and
a uniform resource locator (URL) of the file.

3. The method of claim 1 wherein said retaining comprises executing a probe based on at least one selected from a group consisting of bytecode and kernel mode.

4. The method of claim 1 wherein:
said building comprises accessing a file that is not in the plurality of component files;
said generating the provenance graph comprises inspecting at least one selected from a group consisting of: an identifier of a process, an identifier of a probe, and a call stack;
the method further comprises deciding, based on said inspecting, not to generate a vertex for said file.

5. The method of claim 1 wherein:
said building comprises accessing a file that is not in the plurality of component files;
said generating the provenance graph comprises detecting execution of at least one selected from a group consisting of a class loader and a unit test;
the method further comprises deciding, based on said detecting, not to generate a vertex for said file.

6. The method of claim 1 wherein said generating the provenance graph comprises inspecting a call stack that does not contain a memory address.

7. The method of claim 1 wherein:
the method further comprises generating, for each file of the plurality of component files, a mapping from a memory address to an absolute path of the file;
the memory address is at least one selected from a group consisting of: a kernel memory address and a memory address of a directory entry.

8. The method of claim 1 wherein said building comprises generating at least one selected from a group consisting of a containerization image and an overlay filesystem.

9. The method of claim 1 wherein said retaining comprises invoking a probe in user mode.

10. The method of claim 1 further comprising:
invoking a kernel probe by applying a compiler of the first programing language to the first source file;
invoking said kernel probe by applying a compiler of the second programing language to the second source file.

11. The method of claim 1 wherein:
the method further comprises:
a first probe retaining, in a first record, an URL of a file of the plurality of component files that is being downloaded over a communication network and the distinct identifier of the file, and
a second probe retaining, in a second record, the distinct identifier of the file;
said generating the provenance graph comprises generating a single vertex that represents both of the first record and the second record.

12. One or more non-transitory computer-readable media storing instructions that, when executed by one or more processors, cause:
building a deliverable based on a first source file defined in a first programing language and a second source file defined in a second programing language, wherein:
the building comprises accessing each file of a plurality of component files, and
the accessing each file of the plurality of component files comprises retaining a distinct identifier of the file;
generating a provenance graph that contains a vertex for each file of the plurality of component files, wherein the vertex contains the distinct identifier of the file; and
generating, based on the provenance graph, a dependency report for the deliverable.

13. The one or more non-transitory computer-readable media of claim 12 wherein said retaining the distinct identifier of each file of the plurality of component files comprises retaining at least one selected from a group consisting of:
a version identifier of the file,
a kernel memory address,
a name of a unix system call,
a name of a kernel function, and
a uniform resource locator (URL) of the file.

14. The one or more non-transitory computer-readable media of claim 12 wherein:
said building comprises accessing a file that is not in the plurality of component files;
said generating the provenance graph comprises inspecting at least one selected from a group consisting of: an identifier of a process, an identifier of a probe, and a call stack;
the instructions further cause deciding, based on said inspecting, not to generate a vertex for said file.

15. The one or more non-transitory computer-readable media of claim 12 wherein:
said building comprises accessing a file that is not in the plurality of component files;
said generating the provenance graph comprises detecting execution of at least one selected from a group consisting of a class loader and a unit test;
the instructions further cause deciding, based on said detecting, not to generate a vertex for said file.

16. The one or more non-transitory computer-readable media of claim 12 wherein said generating the provenance graph comprises inspecting a call stack that does not contain a memory address.

17. The one or more non-transitory computer-readable media of claim 12 wherein:
the instructions further cause generating, for each file of the plurality of component files, a mapping from a memory address to an absolute path of the file;
the memory address is at least one selected from a group consisting of: a kernel memory address and a memory address of a directory entry.

18. The one or more non-transitory computer-readable media of claim 12 wherein said retaining comprises invoking a probe in user mode.

19. The one or more non-transitory computer-readable media of claim 12 wherein the instructions further cause:
invoking a kernel probe by applying a compiler of the first programing language to the first source file;
invoking said kernel probe by applying a compiler of the second programing language to the second source file.

20. The one or more non-transitory computer-readable media of claim 12 wherein:
the instructions further cause:
a first probe retaining, in a first record, an URL of a file of the plurality of component files that is being downloaded over a communication network and the distinct identifier of the file, and
a second probe retaining, in a second record, the distinct identifier of the file;
said generating the provenance graph comprises generating a single vertex that represents both of the first record and the second record.
